(19) United States
(12) Patent Application Publication
(10) Pub. No.: US 2023/0167680 A1
(43) Pub. Date: Jun. 1, 2023

(54) DRIVE ASSEMBLY FOR MOVABLE BARRIER

(71) Applicant: Automatic Technology (Australia) Pty Ltd, Keysborough (AU)

(72) Inventors: Raymond Hawkins, Keysborough (AU); Kanav Gupta, Keysborough (AU); Travis Smith, Keysborough (AU); Grant Nicholls, Keysborough (AU)

(21) Appl. No.: 18/058,435

(22) Filed: Nov. 23, 2022

(30) Foreign Application Priority Data
Nov. 26, 2021 (AU) 2021903816

(51) Int. Cl. E06B 9/72

(52) U.S. Cl. CPC E06B 9/72

(57) ABSTRACT

The invention concerns an operator assembly for a movable barrier. The operator assembly includes a motor with a motor output shaft, an output drive to transfer drive to the movable barrier, and a transmission assembly to transfer drive from the motor output shaft to the output drive. The output drive is rotatable in a clockwise direction and in a counterclockwise direction, depending on whether the movable barrier is closing or opening. The output drive comprises a crown wheel rotatable about an output drive axis centre of rotation and having an outer face provided with a plurality of attachment points spaced from said centre of rotation. The operator assembly also includes an output drive adaptor apparatus, the output drive adaptor apparatus including: one or more adaptor portions configured to be removably mounted to the crown wheel through engagement with the plurality of attachment points, and an output drive portion that is concentric with the crown wheel and arranged to drive motion of the movable barrier.

### CROSS REFERENCE TO RELATED APPLICATION

This application claims priority to Australian Patent Application No. 2021903816, filed Nov. 26, 2021. The disclosure set forth in the referenced application is incorporated herein by reference in its entirety.

### FIELD OF THE INVENTION

The invention relates to a drive assembly for a movable barrier. More particularly, it concerns the operative engagement between an output drive of a drive assembly and a movable barrier (such as a door, shutter or similar, etc.) for a garage, shed or other premises.

### BACKGROUND OF THE INVENTION

Movable barrier operator assemblies are well known, one such assembly being that described in Australian Patent 2004100416 for a roller door. Typically, such an assembly includes a chassis supporting an electric motor within a housing, the assembly including a drive train from the motor, which drives a final drive element connected to the roller door to cause the roller door to move up and down through operation of the motor. The roller door is mounted to roll and unroll on a frame including end drum wheels, the frame supported in position by brackets at both ends that hold a mounting axle passing axially through the roller door frame. The operator assembly is mounted at one end of the frame, between one end drum wheel and a bracket to which it is fixed.

The final drive element is generally an internally-toothed crown wheel meshing with the drive train and typically includes extension elements, such as suitably shaped prongs projecting away from the operator assembly body, that operatively engage with the adjacent drum wheel of the roller door frame. In one form, the crown wheel features two prongs, which engage a spoke of the drum wheel in a generally U-shaped configuration, wherein the spoke of the drum wheel is captured by the two prongs extending respectively along the two sides of the spoke. Hence, in one direction of rotation of the crown wheel one of the prongs bears on the spoke to cause the rotation of the roller door, and in the other direction the other prong bears on the spoke to cause the rotation. In another form, the extension elements may be attached (eg. by bolts) to a suitable part of the roller door drum wheel.

It is conventional in the art to provide different forms of operator assemblies in order to drive different types of barriers. The above example, for instance, relates to an operator assembly for a roller door. This need for a different operator assembly to move different types of barriers arises because each operator assembly has its own, often distinct, output drive arrangement, specially configured for engagement with the type of barrier to be driven. This means that a given output drive arrangement will be compatible with some movable barrier arrangements, but incompatible with others. It can be a significant inconvenience to an installer of such operator assemblies to have to accommodate different engagement requirements presented by different barrier types. This will mean the installer will have to have in their inventory different types of operator assemblies in order ensure that they have an available solution for the barrier type encountered.

It is therefore desirable to provide an alternative drive assembly able to address at least partly the inconveniences of the prior art, or to provide a useful alternative to the prior art.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In a first aspect, the present invention provides an operator assembly for a movable barrier, the operator assembly including a motor with a motor output shaft, an output drive to transfer drive to the movable barrier, and a transmission assembly to transfer drive from the motor output shaft to the output drive, the output drive rotatable in a clockwise direction and in a counterclockwise direction, depending on whether the movable barrier is closing or opening,
wherein the output drive comprises a crown wheel rotatable about an output drive axis centre of rotation and having an outer face provided with a plurality of attachment points spaced from said centre of rotation,
the operator assembly including an output drive adaptor apparatus, the output drive adaptor apparatus including:
   one or more adaptor portions configured to be removably mounted to the crown wheel through engagement with the plurality of attachment points, and
   an output drive portion that is concentric with the crown wheel and arranged to drive motion of the movable barrier.

Advantageously, the present invention provides an operator assembly that can be adapted for use with different forms of barriers. This adaptability is provided by the provision of the output drive adaptor apparatus. The output drive adaptor apparatus enables the transmission of drive from the output drive, in particular the crown wheel, to the movable barrier. In this way, an installer of the operator assembly is able to simply equip a compatible output drive adaptor apparatus to an existing or common operator assembly in order to drive different types of movable barriers.

A further advantage arises by provision of an output drive portion that is concentric with the crown wheel. This means that the output drive portion, like the crown wheel, is also rotatable about the output drive axis centre of rotation. This arrangement simplifies the transmission of drive from the motor to component(s) downstream of the output drive portion.

The output drive portion may be operatively associated with each of the one or more adaptor portions. In one embodiment, rotation of the one or more adaptor portions about the output drive axis centre of rotation results in a corresponding rotation of the output drive portion about the output drive axis centre of rotation. The output drive portion may be disposed radially inwardly of the one or more adaptor portions. Preferably, the output drive portion is disposed at or close to the centre of rotation.

In an embodiment, the one or more adaptor portions each have at least one first connection region, said at least one first connection region spaced about the output drive axis centre of rotation when positioned for mounting with the crown wheel. Preferably, the at least one first connection region is adapted to afford mounting of the one or more adaptor portions to the crown wheel through connection with the plurality of attachment points. Each first connection region may be configured to receive at least one fastener to enable connection between the first connection region and a respective attachment point(s) of the crown wheel. The first connection regions may include a plurality of spaced apertures for receiving a fastener. The apertures may be angularly spaced. Preferably, each first connection region includes two apertures. The at least one first connection region is preferably disposed at or towards a radially outer end of the one or more adaptor portions.

The outer face of the crown wheel may include a plurality of shaped attachment portions. The shaped attachment portions may include a recessed locating region enclosing one or more of the attachment points. Each of the one or more adaptor portions may be configured for attachment by multiple fasteners at multiple attachments points associated with the respective shaped attachment portion. For example, two fasteners may be used to affix an adaptor portion at two attachments points associated with a respective shaped attachment portion. Preferably, at least two attachments points associated with the shaped attachment portion are angularly separated on the crown wheel, to assist in resisting lateral forces when rotating and driving the movable barrier.

The crown wheel may include three shaped attachment portions, angularly equispaced about the crown wheel outer face, and preferably positioned at substantially the same radial distance from the centre of the crown wheel. Each of the plurality of shaped attachment portions may include mutually engaging locator means facilitating assembly between the rotating crown wheel and the one or more adaptor portions.

The one or more adaptor portions may each include at least one second connection region, said at least one second connection region spaced about the output drive axis centre of rotation when positioned for mounting with the crown wheel. Preferably, the at least one second connection region is adapted to afford mounting of the output drive portion to the one or more adaptor portions. In this way, the output drive adaptor apparatus is in the form of a multi-part assembly formed by suitable connection of the one or more adaptor portions and the concentric output drive portion. Each second connection region may be configured to receive at least one fastener to enable connection between the second connection region and a respective attachment point(s) on the concentric output drive portion. The second connection regions may include a plurality of spaced apertures for receiving a fastener. The apertures may be angularly spaced. The at least one second connection region is preferably disposed at or towards a radially inner end of the one or more adaptor portions.

In an alternative embodiment, the output drive adaptor apparatus is a single, integrally formed, unitary body.

In one embodiment, the output drive adaptor apparatus includes a single adaptor portion. Preferably the single adaptor portion is of substantially disk shape. The single adaptor portion may have a plurality of first connection regions, said plurality of first connection regions spaced about the output drive axis centre of rotation when positioned for mounting with the crown wheel. Preferably, the plurality of first connection regions are adapted to afford mounting of the single adaptor portion to the crown wheel by connection with the plurality of attachment points. Each first connection region may be configured to receive at least one fastener to enable connection between respective first connection region(s) and a respective attachment point(s) of the crown wheel. The first connection regions may include a plurality of spaced apertures for receiving a fastener. The apertures may be angularly spaced. Preferably, each connection region includes two apertures. The first connection regions are preferably disposed at or towards a radially outer end of the single adaptor portion.

The single adaptor portion may include at least one second connection region, said at least one second connection region spaced about the output drive axis centre of rotation when positioned for mounting with the crown wheel. Preferably, the at least one second connection region is adapted to afford mounting of the output drive portion to the single adaptor portion. Each second connection region may be configured to receive at least one fastener to enable connection between the further connection region and a respective attachment point(s) on the output drive portion. The second connection region(s) may include a plurality of spaced apertures for receiving a fastener. The apertures may be angularly spaced. The second connection regions are preferably disposed at or towards a radially inner end of the single adaptor portion.

The output drive portion may include one or more angularly spaced apertures for receiving a fastener. The fastener may facilitate connection between the one or more adaptor portions and the output drive portion. In one embodiment, at least a portion of the output drive portion is axially spaced away from an outer side of the one or more adaptor portions when the output drive portion is connected thereto. In an alternative embodiment, an inner side of the output drive portion is directly adjacent the outer side of the one or more adaptor portions when the output drive portion is connected thereto.

The concentric output drive portion may include a plurality of teeth circumferentially disposed about an outer periphery thereof, the plurality of teeth configured to operatively engage a longitudinal drive component. The operator assembly may be arranged to drive the longitudinal drive component and thereby drive motion of the movable barrier. For example, driving the longitudinal drive component may drive one or more components downstream of the longitudinal drive component and thereby drive motion of the movable barrier. In another embodiment, the concentric output drive portion includes a groove circumferentially disposed about an outer periphery thereof, the groove configured to operatively engage a longitudinal drive component. The operator assembly may be arranged to drive the longitudinal drive component and thereby drive motion of the movable barrier. The longitudinal drive component may be one of a chain, a belt or similar.

In an embodiment, the output drive portion is a substantially tubular body having an inner bore configured to receive and be operatively coupled to an axle, whereby the operator assembly is arranged to drive the axle and thereby drive motion of the movable barrier. Said driving of the axle may result in direct movement of the movable barrier. In other words, the movable barrier may be rotated upon rotation of the axle. An example of such a “live axle” driven barrier is a jackshaft opener as would be known by a person skilled in the art. In an alternative embodiment, said driving of the axle may indirectly move the movable barrier. In other words, the axle may be operatively engaged with intermediate components of the movable barrier, whereby rotation of the axle results in movement of the intermediate components and then subsequently movement of the movable barrier. One example of such an embodiment is an “offset axle door”, where the drive provided by the axle is transmitted by an intermediate component such as a belt or chain to a further axle or other component (e.g. a wheel of a door drum), movement of said further axle or other said component causing movement of the movable barrier.

The output drive portion may be coupled to the axle by a suitable retention arrangement. For example, the output drive portion may be configured to receive a plurality of fasteners extending transversely through an external side of and circumferentially spaced about a peripheral wall thereof, the fasteners configured to bear against an outer surface of the axle and thereby couple the output drive portion to the axle. In another example, the concentric output drive portion may be configured to receive a cotter pin that extends transversely through external sides of the peripheral wall and through the axle. However, a person skilled in the art will appreciate that other suitable retention arrangements between the axle and the output drive portion can be used such as a splined arrangement, press fit arrangement, etc.

In a second aspect, the present invention provides the abovementioned operator assembly in combination with one of a roller barrier, a tilt door, a sectional door, a barrier with a jackshaft drive, a barrier with an offset axle drive, or a barrier with a live axle drive.

It will be appreciated that features disclosed with respect to the first aspect of the invention are also applicable with respect to the second aspect of the invention described above, including different combinations of features disclosed.

In a third aspect, the present invention provides a roller door operator system, including an output drive adaptor apparatus configured to enable the roller door operator system to drive motion of a movable barrier other than a roller door.

It will be appreciated that features disclosed with respect to the first and second aspects of the invention are also applicable with respect to the third aspect of the invention described above, including different combinations of features disclosed.

It will be understood that ‘roller door’ as used herein covers a full range of roller barriers (e.g. doors, shutters, screens, etc).

Therefore, in an embodiment of the roller door operator system having a plurality of attachment points spaced from said centre of rotation of an associated crown wheel, these attachment points correspond to the attachment points configured for attachment of extension elements that typically drive the drum of a roller door. Thus, the provision of the output drive adaptor apparatus enables the roller door operator system to drive motion of a movable barrier other than a roller door using the attachment points typically reserved for attachment of the extension elements.

Advantageously, when provided with a suitable output drive adaptor apparatus, the roller door operator system can be utilised to drive doors other than roller doors. For example, the roller door operator system can be used to drive tilt doors, sectional doors, etc. These doors may utilise an offset axle drive, a live axle drive, a jackshaft drive, etc. The output drive adaptor apparatus therefore enhances the overall usefulness of the roller door operator system by enabling it to be used with different types of doors.

In a fourth aspect, the present invention provides an output drive adaptor apparatus for the operator assembly for a movable barrier of the first or second aspects, the output drive adaptor apparatus including one or more adaptor portions configured to be removably mounted to the output drive crown wheel through engagement with a plurality of output drive crown wheel attachment points and an output drive portion concentric with the output drive crown wheel and arranged to drive motion of the movable barrier.

It will be appreciated that features disclosed with respect to the first aspect of the invention are also applicable with respect to all other aspects of the invention described above, including different combinations of features disclosed.

As used herein, except where the context requires otherwise, the term “comprise” and variations of the term, such as “comprising”, “comprises” and “comprised”, are not intended to exclude further additives, components, integers or steps.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1 is a perspective view of a typical roller door system;

FIG. 2 is a front perspective view of an operator assembly having an output drive adaptor apparatus in accordance with an embodiment of the invention;

FIG. 3 is a front perspective exploded view of the output drive adaptor apparatus of FIG. 2;

FIG. 4 is a side view of the operator assembly having the output drive adaptor apparatus of FIG. 2;

FIG. 5 is a front perspective view of an operator assembly having a output drive adaptor apparatus in accordance with another embodiment of the invention;

FIG. 6 is a front perspective exploded view of the output drive adaptor apparatus of FIG. 5;

FIG. 7 is a front perspective view of an operator assembly coupled to an axle, the operator assembly having an output drive adaptor apparatus in accordance with another embodiment of the invention;

FIG. 8 is a front perspective view of the output drive adaptor apparatus of FIG. 7; and

FIG. 9 is a front perspective view of an output drive adaptor apparatus in accordance with another embodiment of the invention attached to a crown wheel.

### DETAILED DESCRIPTION OF THE EMBODIMENTS

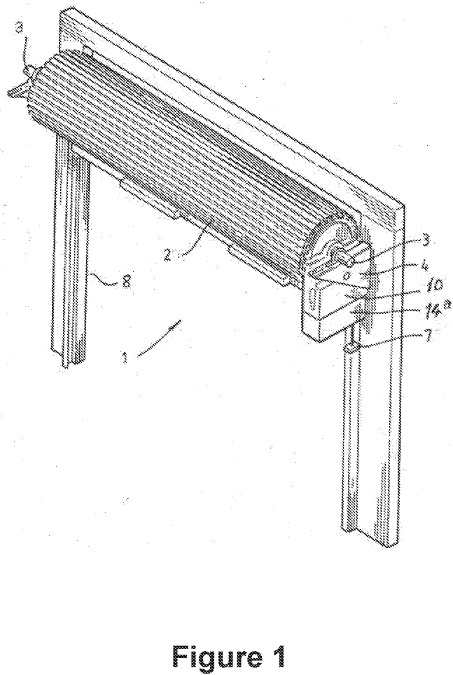

Referring to FIG. 1, a roller door system 1 is provided. System 1 includes a drum-mounted roller door 2 on an axle 3 mounted to two end brackets 4. At one end of the axle 3 is mounted a roller door drive unit 10 including an electric motor and a drive gear train (not shown), as well as an electronic controller unit controlling operation of the motor within a portion 14a of the drive unit. Drive unit 10 is provided with a disengagement pull handle 7 for actuating a clutch for disengagement of the drive train if manual operation of roller door 2 is required at any time. FIG. 1 also shows the garage door opening, defined by outer frame 8. It is to be noted that roller door drive unit 10 illustrated in FIG. 1 is of generally conventional form (for example, of the general form described and illustrated in Australian Patent 2004100416).

In order to drive movement of roller door 2 (i.e. to roll up and unroll the door in order to open and close the garage door opening), drive unit 10 includes as its final drive element an internally-toothed crown wheel mounted for rotation and provided with one or more drive extension elements projecting in the axial direction from an outer face thereof (ie. in a direction parallel to the longitudinal axis of axle 3 once drive unit 10 is in place), for engagement with one or more complementary features of a drum wheel (not shown in FIG. 1) about which roller door 2 is mounted. The drive train of drive unit 10 transfers drive from the output shaft of the electric motor to the crown wheel, the internal teeth of the crown wheel engaging with the teeth of a driven pinion gear of the drive train. Thus, operation of the drive unit electric motor rotates the crown wheel, which thereby rotates the one or more drive extension elements. Rotation of the one or more drive extension elements will result in rotation of the drum wheel resulting in rolling/unrolling of roller door 2.

In one form, the drive extension elements include two prongs which engage a spoke of the drum wheel in a generally U-shaped configuration, wherein the spoke of the drum wheel is captured by the two prongs extending respectively along the two sides of the spoke. Hence, in one direction of rotation of the crown wheel one of the prongs bears on the spoke to cause the rotation of the roller door, and in the other direction the other prong bears on the spoke to cause the rotation. In another form, the extension elements may be attached (eg. by bolts) to a suitable part of the roller door drum wheel.

However, a roller door system of the type shown in FIG. 1 is just one example of a movable barrier system. There are other types of movable barrier systems such as sectional doors, tilt doors, and the like. These barriers may utilise an offset axle drive, a live axle drive, a jackshaft drive, or the like. Each of these different barrier systems is conventionally provided with its own particular type of drive unit for moving the barrier. Thus, installers of these movable barrier systems will incorporate a specific drive unit for each type of movable barrier.

The inventors have identified that it is possible to adapt an existing drive unit, such as a drive unit used in a roller door system, to drive other types of movable barriers. In so doing, the inventors have provided a novel movable barrier operator assembly that utilises a drive unit that has been specially adapted to engage with different forms of movable barriers by the provision of a suitably equipped output drive adaptor apparatus.

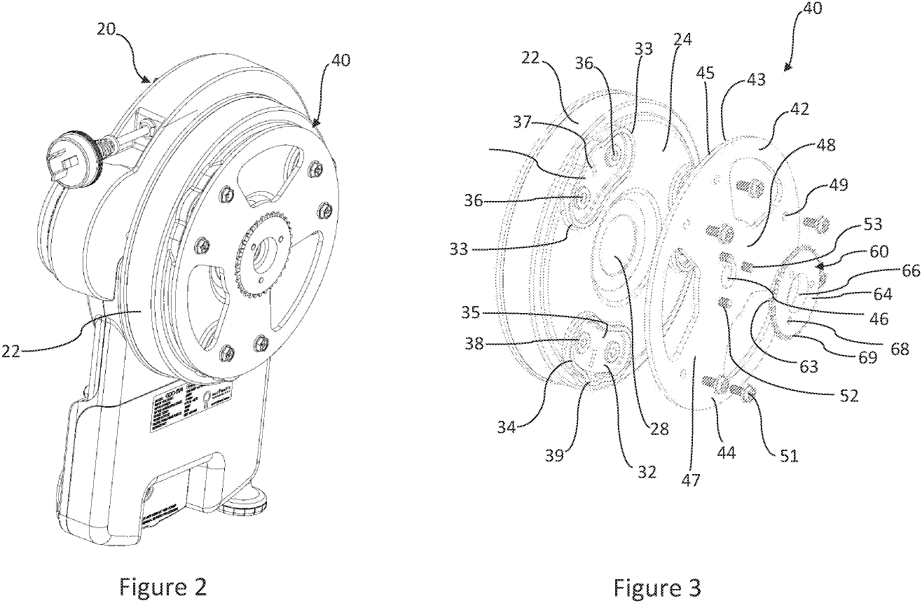

Reference is now made to FIGS. 2 to 4, which illustrate a drive unit 20 in accordance with one embodiment of the present invention. Drive unit 20 is of a similar form and style to roller door drive unit 10 of FIG. 1. Drive unit 20 includes a crown wheel 22 of generally circular shape, having an outer face 24 and an inner side (not shown). It will be appreciated that if drive unit 20 is installed in roller door system 1, the outer surface 24 of crown wheel 22 would face towards and engage the adjacent drum wheel which forms part of a rotating carrier assembly to which the door is mounted (ie. the door drum), whilst the inner side of crown wheel 22 is arranged to operatively engage with the drive train of drive unit 20. In particular, the teeth of a drive pinion gear (not shown) operatively engages the internal gear teeth (not shown) of the crown wheel inner side, thereby causing crown wheel 22 to rotate clockwise or anticlockwise depending on the direction of motor rotation and whether the roller door is being opened or closed.

In roller door system 1, like drive unit 10, drive unit 20 would be installed over roller door axle 3 via a tubular sleeve (not shown) around which bore 28 of crown wheel 22 rotates. Drive unit 20 would be fixedly attached to axle 3 by way of a suitable clamping arrangement. Crown wheel 22 can then be suitably retained against axial movement by a suitable restraining means (eg. a circlip).

Outer face 24 includes a plurality of shaped attachment portions 32. Each of the shaped attachment portions 32 are configured to releasably receive a corresponding output drive extension element such as those described in the Applicant’s earlier patent application AU 2021206794, the disclosure of which is incorporated herein by reference. When driving the drum of a roller door, these output drive extension elements are configured for secure attachment (eg. by bolts) to shaped attachment portions 32 of crown wheel 22, the distal ends of the elements engaging with the roller door drum to rotate it in a clockwise or anticlockwise direction. Details of various features provided in the earlier disclosure that are not specifically relevant to operation of the depicted embodiments will not be discussed in detail here. As will be described in greater detail below, each shaped attachment portion 32 can also releasably receive a portion that forms part of an output drive adaptor apparatus. A total of three like attachment portions 32 are depicted in FIG. 3, but it will be appreciated that any suitable number of shaped attachment portions 32 may be provided. The shaped attachment portions 32 are angularly equispaced about the outer driving face 24 of the crown wheel 22 (ie. at separations of 120º), all positioned at the same radial position relative to a centre of crown wheel 22. It will of course be appreciated that an alternative arrangement of shaped attachment portions 32 may be utilised.

The attachment portions 32 each include a peripheral flange 34 projecting axially from outer face 24. Flange 34 is a closed, curved shape having two opposed rounded end portions 33 joining two generally arcuate portions, the outer of which features a radially protruding rounded central part 39 extending in a generally radial direction. Flange 34 therefore defines an enclosed recessed locating region 35 configured to receive therein a complementary portion of an output drive extension element or a portion that forms part of an output drive adaptor apparatus.

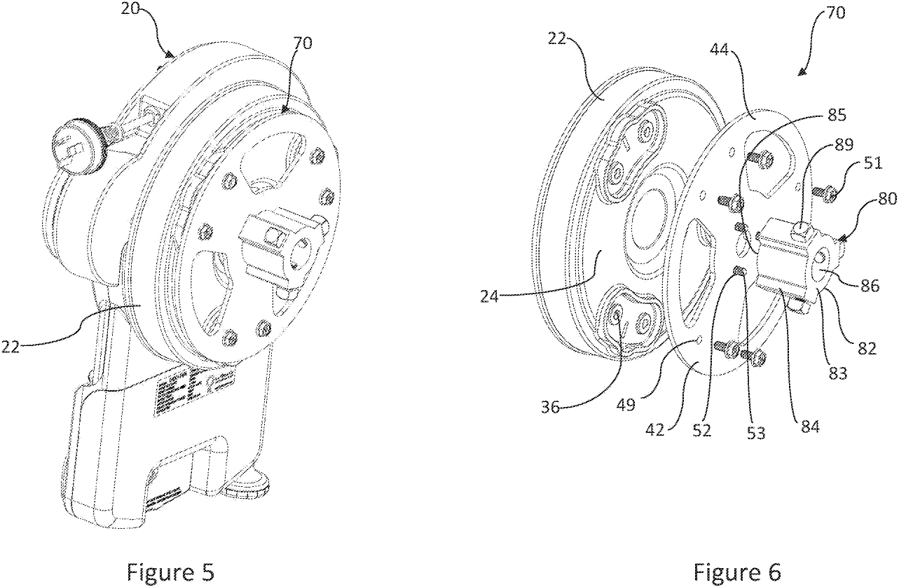

Flange 34 encloses two through holes 36, each configured to receive a fastener for affixing an output drive extension element or a portion that forms part of an output drive adaptor apparatus to crown wheel 22. The through holes 36 are angularly separated from one another around crown wheel 22, to assist in resisting lateral forces when an output drive extension element or a portion that forms part of an output drive adaptor apparatus is attached to crown wheel 22 (see FIGS. 2 and 5). An annular rim 38 projects from outer face 24 and surrounds each through hole 36. Flange 34 also encloses an elongated slot 37, oriented in the radial direction, disposed between the two through holes 36. Slot 37 and rims 38 can act as locating features, facilitating assembly and firm engagement between crown wheel 22 and other components face mounted thereto.

Output drive adaptor apparatus 40 is configured to be releasably mounted to crown wheel 22. Output drive adaptor apparatus 40 includes an adaptor disk 42 having an inner face 43, a substantially parallel outer face 44 spaced away from the inner face 43, and a side wall 45 extending between the inner face 43 and outer face 44. A substantially circular bore 46 extends through a centre of adaptor disk 42 between inner face 43 and outer face 44. When adaptor portion 42 is mounted to crown wheel 22, bore 46 is positioned concentric with bore 28 of crown wheel 22.

Adaptor disk 42 includes a plurality (three in the depicted embodiments) of radially extending portions 47 extending from and angularly spaced about a central hub 48 of adaptor disk 42. Portions 47 are angularly equispaced (about 120°) in the depicted embodiments, but it will be appreciated that alternative arrangements may be utilised. Each portion 47 includes a pair of apertures 49 angularly spaced about the centre of rotation of disk 42. Apertures 49 are configured to receive a suitable fastener 51 in order to enable releasable mounting of disk 42 to the outer face 24 of the crown wheel 22. Disk 42 is provided with six apertures 49 in total, and each aperture is configured to be aligned with through holes 36 of crown wheel 22 when adaptor disk 42 is suitably positioned about crown wheel 42. Fasteners 51 and the internal periphery of through holes 36 are threaded, thereby enabling suitable threaded engagement between fastener 51 and through hole 36. However, it will be appreciated that different fastening arrangements can be utilised to releasably mount disk 42 to crown wheel 22.

Central hub 48 also includes a plurality (three in the depicted embodiments) of apertures 52 angularly spaced about bore 46 of adaptor disk 42. Apertures 52 are angularly equispaced (about 120°) in the depicted embodiments, but it will be appreciated that alternative arrangements may be utilised. Apertures 52 are configured to receive suitable fasteners 53 in order to releasably mount a suitable output drive portion as will now be explained in detail.

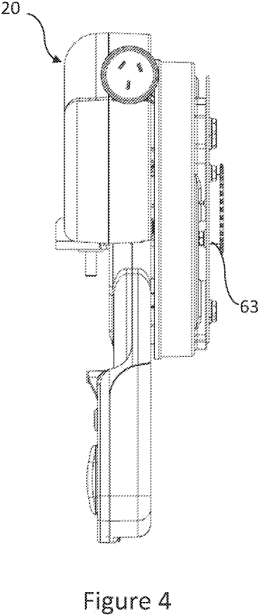

In the embodiment shown in FIGS. 2 to 4, the output drive portion is in the form of a drive transmitting sprocket 60 configured to be releasably mounted to adaptor disk 42. Sprocket 60 has an inner side including a radially inner hub 63 (best shown in FIG. 4) and an outer side including a sprocket wheel 64. Extending radially from the outer periphery of sprocket wheel 64 is a plurality of teeth 69 configured to operatively engage with a longitudinal drive component (not shown) such as a belt or chain. A substantially circular bore 66 extends through a centre of sprocket 60 between the inner and outer sides thereof.

Sprocket 60 includes a plurality (three in the depicted embodiments) of apertures 68 angularly spaced about bore 66. For the reason explained further below, apertures 68 are positioned on hub 63. Apertures 68 are configured to receive fasteners 53 in order to enable releasable mounting of sprocket 60 to outer face 44 of disk 42. In particular, each aperture 68 is configured to be aligned with apertures 52 of adaptor disk 42 when sprocket 60 is suitably positioned about adaptor disk 42. Fasteners 53 and the internal periphery of apertures 68 are threaded, thereby enabling suitable threaded engagement between fastener 53 and apertures 68. However, it will be appreciated that different fastening arrangements can be utilised to releasably mount sprocket 60 to disk 42.

When sprocket 60 is mounted to adaptor disk 42, bore 66 is positioned concentric with bore 28 of crown wheel 22. It will be appreciated that when sprocket 60 is mounted to adaptor disk 42, an inner face of hub 63 is configured to bear against outer face 44 of adaptor disk 42. The thickness of hub 63 defines an axial spacing or standoff between outer face 44 of adaptor disk 42 and sprocket wheel 64. This spacing is provided to accommodate the longitudinal drive component to avoid interference between this component and adaptor disk 42. Thus, when fastening sprocket 60 to adaptor disk 42, the thickness of the hub 63 defines the spacing between sprocket wheel 64 and adaptor disk 42. In the event that a larger spacing is required to accommodate a wider longitudinal drive component, spacing elements between the sprocket 60 and the adaptor disk 42 may be added. In the depicted example, the axial spacing is approximately 8 mm.

It will be appreciated that in the current embodiment, sprocket 60 is releasably mounted to adaptor disk 42 by first correctly aligning the sprocket 60 and adaptor disk 42 so that apertures 68 of the sprocket and apertures 52 of the adaptor disk 42 are suitably aligned. Threaded fasteners 53 are then received from the inner side of adaptor disk 42 and screwed through the apertures 68 of the sprocket 60. As shown in FIG. 2, the ends of fasteners 53 are about flush with the outer face of sprocket wheel 64 when fasteners 53 are screwed all the way through apertures 68. Next, the output drive adaptor apparatus 40 (consisting of the combined adaptor disk 42 and sprocket 60) is releasably mounted to the outer face 24 of crown wheel 22. This is achieved by firstly correctly aligning the output drive adaptor apparatus 40 and crown wheel 22 so that apertures 49 of the adaptor disk 42 and through holes 36 of the crown wheel 22 are suitably aligned. Threaded fasteners 51 are then received from the outer face 44 of adaptor disk 42 and through apertures 49 and extend through to through holes 36 of crown wheel 22 in a threaded engagement.

With output drive adaptor apparatus 40 now releasably mounted to crown wheel 22, drive unit 20 is now adapted to drive a suitable movable barrier. In other words, drive unit 20, which is originally designed to drive motion of a roller door through direct engagement with a drum wheel of the roller door, is now capable of driving a different form of door. When crown wheel 22 is driven to rotate in the conventional way as mentioned above, output drive adaptor apparatus 40 will now also be caused to rotate about the output drive axis centre of rotation. This will include rotation of sprocket 60. Thus, as will be appreciated by a person skilled in the art, when sprocket 60 is operatively engaged with a longitudinal drive component, such as a belt or chain, drive unit 20 will be able to drive the belt or chain, which in turn will drive other downstream components operatively associated with the movable barrier. In one example, output drive adaptor apparatus 40 enables drive unit 20 to drive motion of an offset axle door, which can be moved by rotation of a shaft or axle driven by operative engagement with the belt or chain.

Reference is now made to FIGS. 5 and 6, which depict an alternative output drive adaptor apparatus 70. It will be appreciated that the main difference between output drive adaptor apparatus 40 and output drive adaptor apparatus 70 relates to the output drive portion. In this embodiment, the output drive portion is in the form of a shaft coupler 80. Similar to sprocket 60, shaft coupler 80 is configured to be releasably mounted to adaptor disk 42. Coupler 80 is in the form of a substantially tubular element 82 having three radially extending stiffening members 84 that traverse along the length of tubular element 82. Stiffening members 84 are angularly equispaced about a central bore 86, which extends from an outer face 83 of tubular element 82 to an inner face 85 of tubular element 82. Bore 86 is sized to receive therein an end of a shaft (not shown) that is to be driven by drive unit 20. The shaft is suitably retained within coupler 80 by a plurality of grub screws 89 (three grub screws in this example), which are configured to bear on an external periphery of the shaft. Each grub screw 89 is provided in an aperture (not shown) extending transversely through a respective stiffening member 84 of tubular element 82.

Inner face 85 of tubular element 82 includes a plurality (three in this embodiment) of apertures (not shown) angularly spaced about bore 86. These apertures are configured to receive fastener 53 in order to enable releasable mounting of coupler 80 to outer face 44 of disk 42. In particular, each aperture is configured to be aligned with apertures 52 of adaptor disk 42 when coupler 80 is suitably positioned about adaptor disk 42. Fasteners 53 and the internal periphery of the apertures are threaded, thereby enabling suitable threaded engagement between fastener 53 and the apertures.

It will be appreciated that in the current embodiment, coupler 80 is releasably mounted to adaptor disk 42 by first correctly aligning the coupler 80 and adaptor disk 42 so that the apertures of the coupler 80 and apertures 52 of the adaptor disk 42 are suitably aligned. Threaded fasteners 53 are then received from the inner side of adaptor disk 42 and screwed through the apertures of the coupler 80. Next, the output drive adaptor apparatus 70 (consisting of the combined adaptor disk 42 and coupler 80) is releasably mounted to the outer face 24 of crown wheel 22. This is achieved by firstly correctly aligning the output drive adaptor apparatus 70 and crown wheel 22 so that apertures 49 of the adaptor disk 42 and through holes 36 of the crown wheel 22 are suitably aligned. Threaded fasteners 51 are then received from the outer face 44 of adaptor disk 42 and through apertures 49 and extend through to through holes 36 of crown wheel 22 in a threaded engagement.

With output drive adaptor apparatus 70 now releasably mounted to crown wheel 22, drive unit 20 is now adapted to drive a suitable movable barrier. For example, the present embodiment is suitable to drive a live axle door (i.e. a door driven by rotation of the shaft to move the door). An end of the shaft is received in bore 86, the shaft having a smaller diameter than bore 86 in order to allow an end of the shaft to slide into bore 86. The shaft is constrained by grub screws 89, which are screwed towards the shaft until they bear tightly on the external periphery of the shaft. When crown wheel 22 is driven to rotate in the conventional way as mentioned above, output drive adaptor apparatus 70 will now also be caused to rotate about the output drive axis centre of rotation. This will include rotation of coupler 80. Thus, as will be appreciated by a person skilled in the art, when coupler 80 is operatively engaged with the shaft, drive unit 20 will be able to drive the shaft, which in turn will drive the movable barrier.

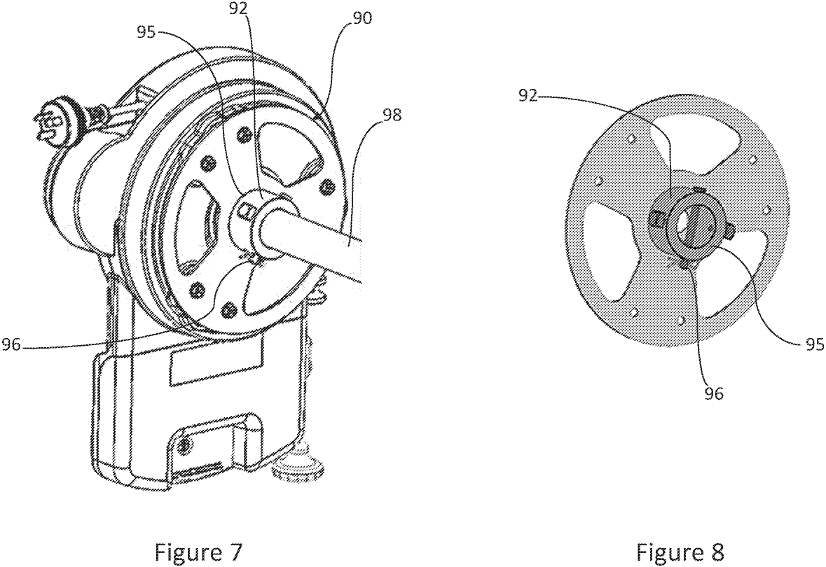

Reference is now made to FIGS. 7 and 8 that show an alternative output drive adaptor apparatus 90. Output drive adaptor apparatus 90 is similar in many respects to output drive adaptor apparatus 70, save for some slight variation in the shaft coupler 95 and how it constrains the shaft. Notably, shaft coupler 95 includes a clevis/cotter pin arrangement 96, the clevis pin configured to extend through opposed apertures (not shown) extending transversely through a tubular element 92 and through shaft 98. This embodiment is otherwise functionally the same as the previous shaft coupler embodiment.

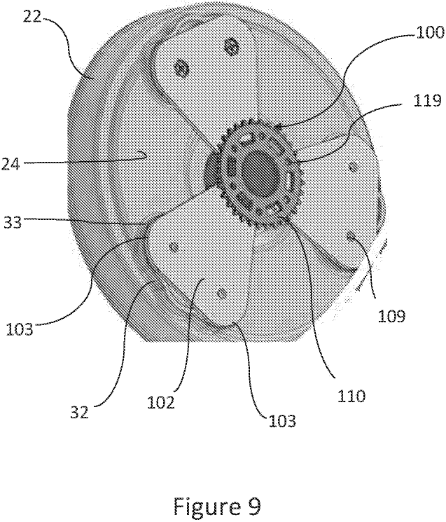

Reference is now made to FIG. 9, which shows another alternative output drive adaptor apparatus 100. It will be appreciated that FIG. 9 is a cropped image of output drive adaptor apparatus 100, and therefore omits some detail (particularly around the left, lower right and lower parts thereof). Output drive adaptor apparatus 100 includes three adaptor extension elements 102 each configured to be releasably mounted to the outer face 24 of crown wheel 22. Each extension element 102 is a substantially planar body that tapers in width from a radially outer end thereof to a radially inner end thereof with respect the crown wheel 22. The radially outer end of each extension element 102 includes two opposed rounded end portions 103 that generally correspond in shape to the rounded end portions 33 of shaped attachment portions 32. Also provided towards the radially outer end of each extension element is a pair of apertures 109 angularly spaced about the centre of rotation of crown wheel 22. Apertures 109 are configured to receive a suitable fastener (not shown) in order to enable releasable mounting of extension element 102 to the outer face 24 of the crown wheel 22. The extension elements 102 together include six apertures 109, and each aperture 109 is configured to be aligned with through holes 36 of crown wheel 22 when each respective extension element 102 is suitably positioned about crown wheel 22. The fasteners and the internal periphery of through holes 36 are threaded, thereby enabling suitable threaded engagement between each fastener and through hole 36.

The radially inner end of each extension element 102 is mounted to a sprocket 110, which is of similar form to sprocket wheel 64. Sprocket 110 is mounted to the extension elements by suitable fasteners (not shown), which not only connects the sprocket 110 to the extension elements 102, but also spaces the sprocket 110 from the outer face of the extension elements 102 in order to accommodate a longitudinal drive component (as mentioned with respect to one of the earlier embodiments). The fasteners are received in the apertures 119 (six apertures in this embodiment).

It will be appreciated that in the current embodiment, sprocket 110 is releasably mounted to extension elements 102 by first correctly aligning the sprocket 110 and extension elements 102 so that the apertures 119 of the sprocket 110 and apertures (not shown) of the extension elements 102 are suitably aligned. Threaded fasteners are then received from the inner side of each extension element 102 and screwed through the apertures 119 of the sprocket 110. Next, the output drive adaptor apparatus 100 (consisting of the combined extension elements 102 and sprocket 110) is releasably mounted to the outer face 24 of crown wheel 22. This is achieved by firstly correctly aligning the output drive adaptor apparatus 100 and crown wheel 22 so that apertures 119 of the extension elements 102 and through holes 36 of the crown wheel 22 are suitably aligned. Threaded fasteners are then received from the outer face of extension element 102 and through apertures 119 and extend through to through holes 36 of crown wheel 22 in a threaded engagement.

With output drive adaptor apparatus 100 now releasably mounted to crown wheel 22, drive unit 20 is now adapted to drive a suitable movable barrier. In other words, drive unit 20, which is originally designed to drive motion of a roller door through direct engagement with a drum wheel of the roller door, is now capable of driving a different form of door. When crown wheel 22 is driven to rotate in the conventional way as mentioned above, output drive adaptor apparatus 100 will now also be caused to rotate about the output drive axis centre of rotation. This will include rotation of sprocket 110. Thus, as will be appreciated by a person skilled in the art, when sprocket 110 is operatively engaged with a longitudinal drive component, such as a belt or chain, drive unit 20 will be able to drive the belt or chain, which in turn will drive other downstream components operatively associated with the movable barrier.

As will be appreciated, the various embodiments described above and illustrated in the figures each provide the ability to make use of the crown wheel of a conventional roller door drive unit to attach a dedicated adaptor, specially sized and shaped for fixation to the mounting points provided for attachment of roller door drive extension pieces, the adaptor including a dedicated adaptor output part to provide drive to a door (or other closure) other than a roller door.

Thus, by provision of a suitable output drive adaptor apparatus, drive unit 20 of the present invention is capable of not only driving motion of a conventional roller door (i.e. a door mounted to roll around a fixed axle), but drive motion of other forms of doors including sectional doors, tilt doors and the like which may involve substantially different mechanisms, such as an offset axle, a torson-spring-loaded live axle, a jackshaft, etc. The present invention therefore enables an installer to adapt a roller door operator to drive motion of other doors by selecting and equipping a suitable output drive adaptor apparatus for a given operator assembly.

Whilst the embodiments described related to output drive adaptor apparatus that are a multi-part assembly (e.g. the adaptor disk and output drive portions), in alternative embodiments, the output drive adaptor apparatus may be a single, integrally formed unitary body. For example, in the embodiment of FIGS. 2 to 4, adaptor disk 42 and sprocket 60 may be fabricated or supplied as a single, unitary body for selection by the installer if it is determined that the barrier is to be driven by way of a belt or chain. Further, in alternative embodiments to that described above, a single output drive portion may be configured to accommodate both a longitudinal drive component (e.g. by way of a suitable sprocket) and include a bore for receiving an end of a shaft or axle. Thus, an installer can simply utilise a suitable part of the output drive portion, based on the type of barrier and/or the downstream components for which the drive unit 20 is to drive.

The output drive adaptor apparatus 40 may be made of any suitable material to meet the intended operational requirements of drive unit 20. In a prototype tested, output drive adaptor apparatus 40 was made of mild steel with a diameter of 200 mm and a thickness of 2 mm. Exemplary dimensions are 180-250 mm for the diameter of output drive adaptor apparatus 40 and 2-5 mm thickness. The drive transmitting sprocket 60, shaft couplers 80, 95 and clevis pin 96 may be made of any suitable material to meet the intended operational requirements of drive unit 20. In a prototype tested, drive transmitting sprocket 60, shaft couplers 80, 95 and clevis pin 96 were made of a high grade steel. Exemplary dimensions for the shaft couplers 80, 95 include an external diameter of 45-60 mm and a depth of 20-40 mm. Exemplary dimensions for drive transmitting sprocket 60, 110 include a diameter of 20-60 mm.

It will be understood that the invention disclosed and defined in this specification extends to all alternative combinations of two or more of the individual features mentioned or evident from the text or drawings. All of these different combinations constitute various alternative aspects of the invention.

1. An operator assembly for a movable barrier, the operator assembly including a motor with a motor output shaft, an output drive to transfer drive to the movable barrier, and a transmission assembly to transfer drive from the motor output shaft to the output drive, the output drive rotatable in a clockwise direction and in a counterclockwise direction, depending on whether the movable barrier is closing or opening,
wherein the output drive comprises a crown wheel rotatable about an output drive axis centre of rotation and having an outer face provided with a plurality of attachment points spaced from said centre of rotation,
the operator assembly including an output drive adaptor apparatus, the output drive adaptor apparatus including:
one or more adaptor portions configured to be removably mounted to the crown wheel through engagement with the plurality of attachment points, and
an output drive portion that is concentric with the crown wheel and arranged to drive motion of the movable barrier.

2. The operator assembly of claim 1, wherein the output drive portion is operatively associated with each of the one or more adaptor portions.

3. The operator assembly of claim 2, wherein rotation of the one or more adaptor portions about the output drive axis centre of rotation results in a corresponding rotation of the output drive portion about the output drive axis centre of rotation.

4. The operator assembly of claim 1, wherein the output drive portion is disposed radially inwardly of the one or more adaptor portions.

5. The operator assembly of claim 4, wherein the output drive portion is disposed at or close to the output drive axis centre of rotation.

6. The operator assembly of claim 1, wherein the one or more adaptor portions each have at least one first connection region, said at least one first connection region spaced about the output drive axis centre of rotation when positioned for mounting with the crown wheel.

7. The operator assembly of claim 6, wherein the at least one first connection region is adapted to afford mounting of the one or more adaptor portions to the crown wheel through connection with the plurality of attachment points.

8. The operator assembly of claim 6, wherein the at least one first connection region is disposed at or towards a radially outer end of the one or more adaptor portions.

9. The operator assembly of claim 1, wherein the outer face of the crown wheel includes a plurality of shaped attachment portions.

10. The operator assembly of claim 9, wherein the shaped attachment portions include a recessed locating region enclosing one or more of the attachment points.

11. The operator assembly of claim 10, wherein each of the one or more adaptor portions are configured for attachment by multiple fasteners at multiple attachments points associated with the respective shaped attachment portion.

12. The operator assembly of claim 1, wherein the one or more adaptor portions each include at least one second connection region, said at least one second connection region spaced about the output drive axis centre of rotation when positioned for mounting with the crown wheel.

13. The operator assembly of claim 12, wherein the at least one second connection region is adapted to afford mounting of the output drive portion to the one or more adaptor portions.

14. The operator assembly of claim 1, wherein the output drive adaptor apparatus includes a single adaptor portion.

15. The operator assembly of claim 14, wherein the single adaptor portion is of substantially disk shape.

16. The operator assembly of claim 1, wherein the output drive portion includes a plurality of teeth or a groove circumferentially disposed about an outer periphery thereof, the plurality of teeth or the groove being configured to operatively engage a longitudinal drive component.

17. The operator assembly of claim 1, wherein the output drive portion is a substantially tubular body having an inner bore configured to receive and be operatively coupled to an axle, whereby the operator assembly is arranged to drive the axle and thereby drive motion of the movable barrier.

18. The operator assembly of claim 1 in combination with one of a roller barrier, a tilt door, a sectional door, a barrier with a jackshaft drive, a barrier with an offset axle drive, or a barrier with a live axle drive.

19. An output drive adaptor apparatus for the operator assembly for a movable barrier of claim 1, the output drive adaptor apparatus including one or more adaptor portions configured to be removably mounted to the output drive crown wheel through engagement with a plurality of output drive crown wheel attachment points and an output drive portion concentric with the output drive crown wheel and arranged to drive motion of the movable barrier.

20. A roller door operator system, including an output drive adaptor apparatus configured to enable the roller door operator system to drive motion of a movable barrier other than a roller door.
